(19) United States
(12) Patent Application Publication
(10) Pub. No.: US 2026/0328930 A1
(43) Pub. Date: Oct. 22, 2026

(54) REAL-TIME CREVASSE DETECTION SYSTEM

(71) Applicant: Battelle Memorial Institute, Columbus, OH (US)

(72) Inventors: David A. Friedenberg, Worthington, OH (US); Andrew Matas, Columbus, OH (US); Katherine E. Murphy, Boulder, CO (US); Jordan L. Vasko, Columbus, OH (US); Matthew A. Zeglen, Columbus, OH (US); Nicholas Romano, Livingston, MT (US); Seth Campbell, Seattle, WA (US)

(21) Appl. No.: 19/650,900

(22) Filed: Apr. 17, 2026

Related U.S. Application Data
(60) Provisional application No. 63/790,337, filed on Apr. 17, 2025.

(51) Int. Cl. G01S 13/88; G01S 13/89; G01V 20/00; G06T 5/50; G06T 5/73

(52) U.S. Cl. CPC G01S 13/885; G01S 13/89; G01V 20/00; G06T 5/50; G06T 5/73

(57) ABSTRACT

A real-time crevasse detection system comprising a ground penetrating radar configured to traverse over a surface of a terrain while gathering subsurface data by emitting radio waves towards the surface and measuring reflections of the radio waves; and a processor configured to identify crevasses within the subsurface data.

### CROSS REFERENCE TO RELATED APPLICATIONS

This application claims the benefit of U.S. Provisional Application Ser. No. 63/790,337, filed Apr. 17, 2025, which is hereby incorporated by reference in its entirety.

### TECHNICAL FIELD

The present disclosure is generally directed to a real-time crevasse detection system.

### BACKGROUND

Traveling over glaciers and other snow and/or ice-covered terrain can be dangerous because crevasses, or splits in the ice or underlying earth, can be lurking under the surface unbeknownst to the travelers. Traveling on a surface with an unknown crevasse hiding below can be dangerous because the layer of earth, snow, and/or ice covering the crevasse can give way to the weight of the traveling individual or vehicle causing them to fall into the crevasse risking injury or even death.

Ground penetrating radar (GPR) is a technology that can provide insight into features of a terrain laying under the surface. GPR works by emitting radio waves into the ground and measuring the reflections off the features laying underground. The measurements taken can then be interpreted by experts who understand the relationships between GPR measurements and the features that may lay beneath the surface such as crevasses. However, when GPR data needs to be monitored continuously, for example, while a vehicle is moving across an ice-covered terrain, an expert may become fatigued and susceptible to making mistakes in interpreting the data. Therefore, there exists a need for a real-time crevasse detection system which does not rely on a human's constant monitoring.

### BRIEF DESCRIPTION OF THE DRAWINGS

The above-mentioned and other features of this disclosure, and the manner of attaining them, will become more apparent and better understood by reference to the following description of embodiments described herein taken in conjunction with the accompanying drawings, wherein:

FIG. 1 shows a schematic diagram of an example of a real-time crevasse detection system, consistent with the embodiments of the present disclosure.

FIG. 2 shows a representation of subsurface data collected using a ground penetrating radar, consistent with the embodiments of the present disclosure.

FIGS. 3A-3C shows interpretation outputs produced by the crevasse detection system, consistent with the present disclosure.

FIG. 4 shows a method of training and using a vision model to identify a crevasse in data captured using ground penetrating radar, consistent with the embodiments of the present disclosure.

FIG. 5 shows a method of preparing data to be used in the training of a vision model to identify a crevasse in data captured using ground penetrating radar consistent with the present disclosure.

FIG. 6 shows a method of data augmentation.

FIG. 7 shows a schematic of an embodiment of a method of using transfer learning to train a vision model.

FIG. 8 shows a schematic of an embodiment of a method of using transfer learning to train a vision model.

FIG. 9 depicts a representation of a method of generating a trained vision model that may be used to identify a crevasse in data captured using ground penetrating radar.

FIG. 10 depicts a method of performing crevasse detection on real-time ground penetrating radar data

### DETAILED DESCRIPTION

The present disclosure is not limited in its application to the details of construction and the arrangement of components set forth in the following description or illustrated in the drawings. The examples described herein may be capable of other embodiments and of being practiced or being carried out in various ways. Also, it may be appreciated that the phraseology and terminology used herein is for the purpose of description and should not be regarded as limiting as such may be understood by one of skill in the art. Throughout the present description, like reference characters may indicate like structure throughout the several views, and such structure need not be separately discussed. Furthermore, any particular feature(s) of a particular exemplary embodiment may be equally applied to any other exemplary embodiment(s) of this specification as suitable. In other words, features between the various exemplary embodiments described herein are interchangeable, and not exclusive.

The present disclosure is generally directed to a real-time crevasse detection system. More specifically, the present disclosure relates to a crevasse detection system comprising a ground penetrating radar configured to traverse the surface of a terrain, capture data, and identify crevasses and/or other subsurface features in the data.

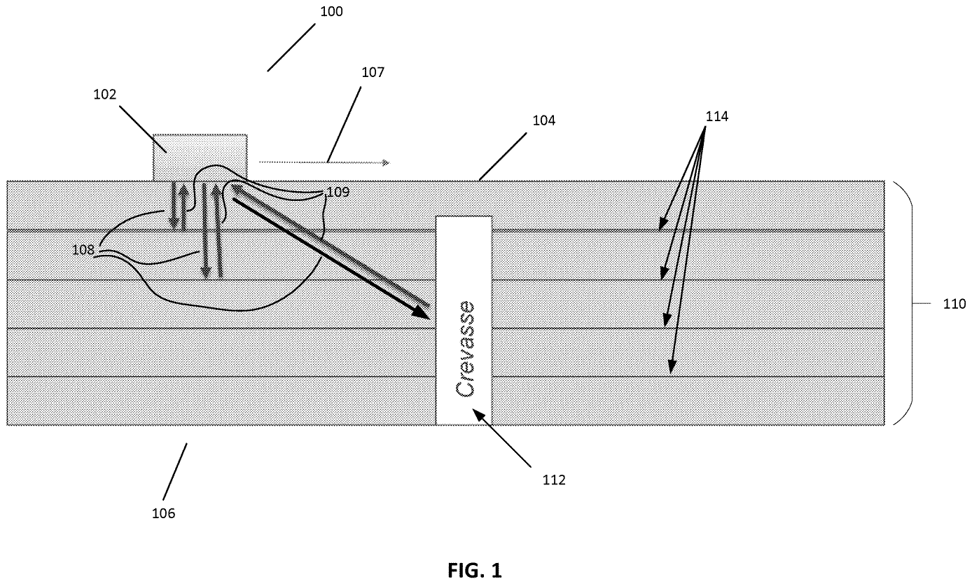

An embodiment of the present disclosure is depicted in FIG. 1. The real-time crevasse detection system 100 includes a ground penetrating radar 102 configured to traverse a surface 104 of a terrain 106 in a direction 107. The ground penetrating radar 102 is configured to capture subsurface data by emitting radio waves 108 towards the surface 104 and measuring their reflections 109 off the features within the subsurface 110. The reflections 109 occur when the radio waves 108 encounter boundaries 114 between layers having different compositions or electrical properties in the subsurface 110 and/or crevasses 112 in the subsurface 110. The real-time crevasse detection system 100 may further be configured to interpret the subsurface data to identify subsurface features (e.g., crevasses 112 and/or layer boundaries) which may exist in the subsurface 110.

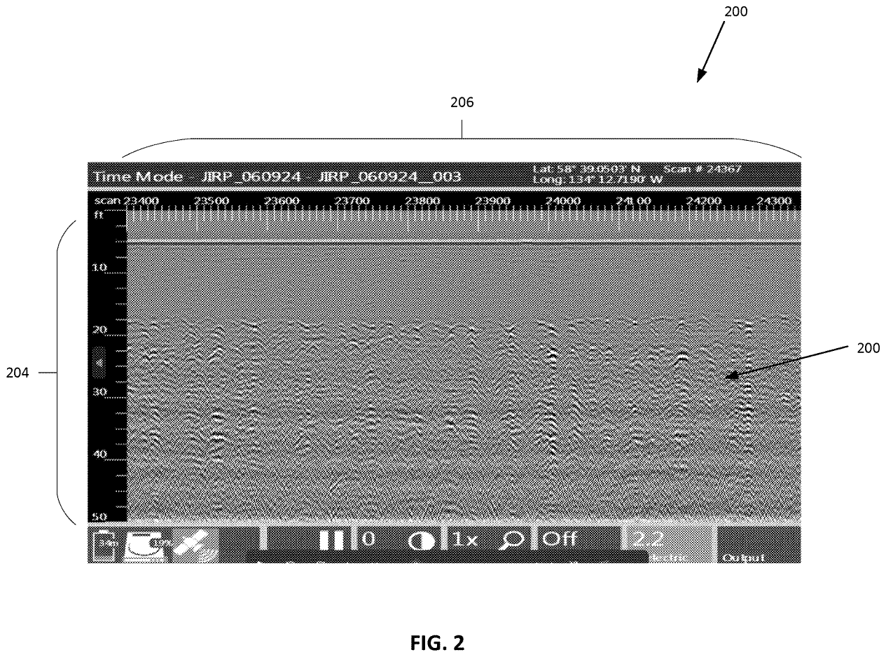

FIG. 2 depicts an example of a representation of the subsurface data 200 collected by the ground penetrating radar 102. The subsurface data 200 shown in FIG. 2 is a screen capture from an SIR-4000 ground penetrating radar control unit produced by Geophysical Survey Systems, Inc. (“GSSI”). Subsurface data 200 collected by the SIR-4000 may be accessed, for example, by downloading DZT files saved by the SIR-4000. DZT files contain binary representations of the subsurface data 200 collected by the ground penetrating radar 102. DZT files containing subsurface data 200 can be saved periodically. Upon saving the DZT files, the crevasse detection system 100 can access the DZT files and interpret the subsurface data 200 contained therein to identify crevasses in the data in offline analyses. Another way in which subsurface data 200 collected by the SIR-4000 can be utilized is to access a streaming video feed of the real-time subsurface data 200 displayed on the control unit of the SIR-4000 as shown in FIG. 2. The subsurface data 200 may then be understood by the real-time crevasse detection system 100 as pixel values within the video feed. The crevasse detection system may also be configured to work with alternative ground penetrating radar control units which may stream the subsurface data 200 directly to the detection system 100 in real-time.

The subsurface data 200 depicted in FIG. 2 is more specifically a graphical representation of the reflections 109 measured by the ground penetrating radar 102. The vertical axis 204 of the graphical representation of the subsurface data 200 corresponds to the depth the radio waves 108 traveled before being reflected back to the ground penetrating radar 102. The horizontal axis 206 of the graphical representation of the subsurface data 200 corresponds to individual measurements of the reflections 109 detected by the ground penetrating radar 102 at periodic increments. Because the ground penetrating radar 102 is traversing the surface 104 while periodically measuring the reflections 109, the horizonal axis 206 also corresponds to a distance travelled over the surface 104 by the ground penetrating radar 102.

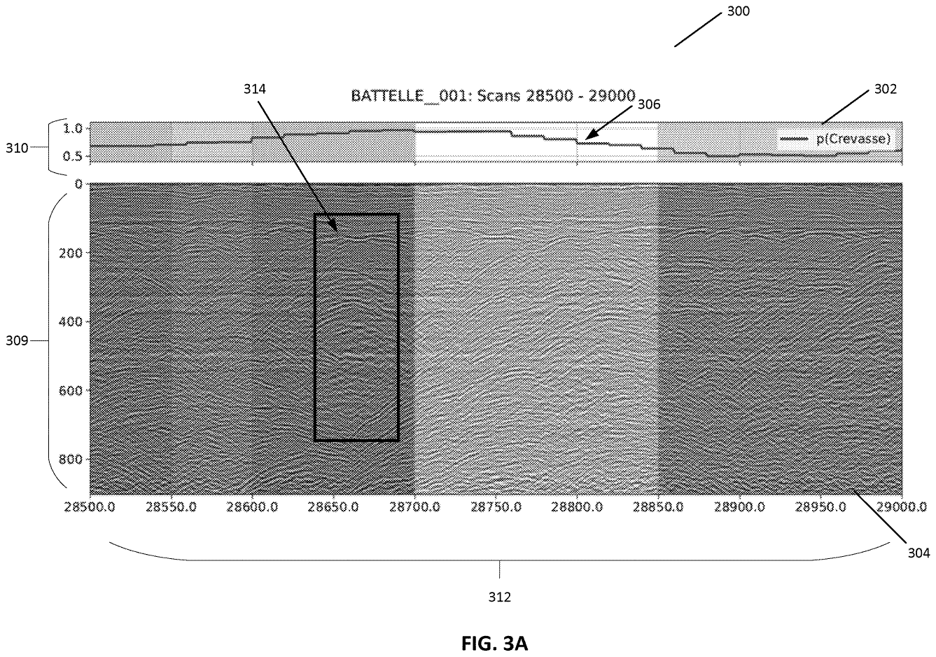

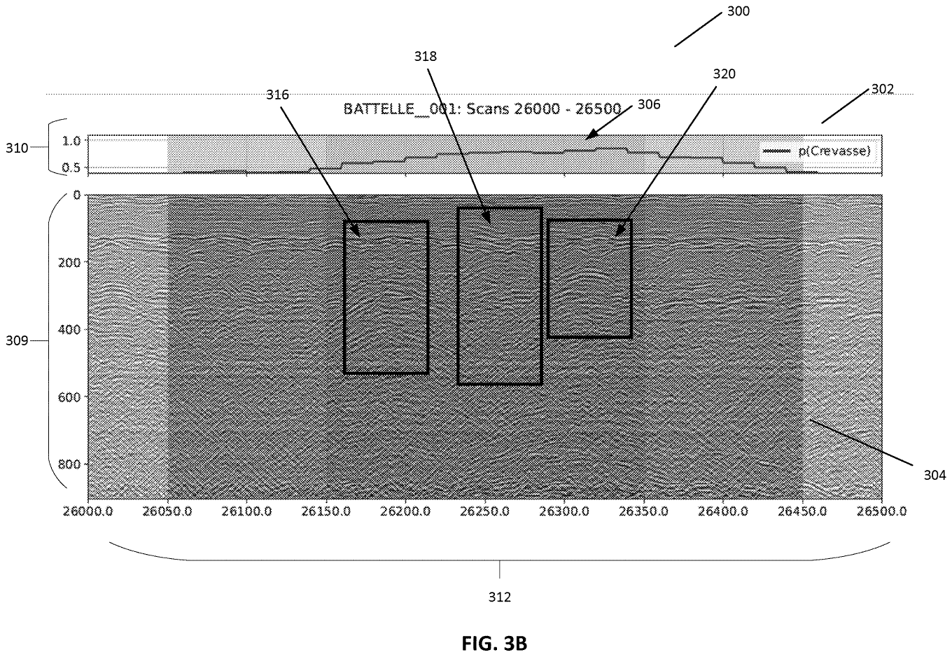

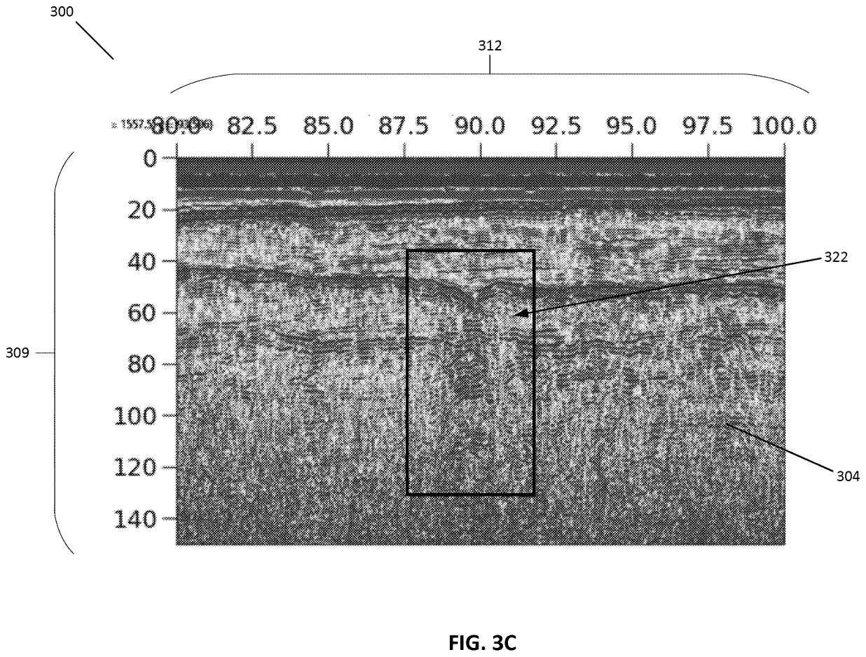

FIGS. 3A & 3B are examples of an interpretation output 300 made by the crevasse detection system 100. The interpretation output 300 includes a crevasse indication graph 302 and may additionally include a graphical representation 304 of the reflection 109, which may optionally have undergone preprocessing prior to display. The crevasse indication graph 302 indicates an identified crevasse prediction curve 306 and the graphical representation 304 shows patterns interpreted by the real-time crevasse detection system 100 as indicating a certain predicted probability of a crevasse existing at that location. The vertical axis 309 of the graphical representation 304 represents the depth the radio waves 108 traveled before being reflected back to the ground penetrating radar 102. The vertical axis 310 of the crevasse identification graph 302 represents the predicted probability that a crevasse is indicated within that region, where 0 represents a region where the predicted probability of there being a crevasse is 0% and 1 represents a region where the predicted probability of there being a crevasse is 100%. The graphical representation 304 and the identification graph 302 contain color-coded regions representing human-generated labels. The colors correspond to a specific label where green represents no crevasse detected, red represents a crevasse is detected and yellow represents an ambiguous region or “weak” crevasses. These color-coded regions would not appear on interpretation outputs generated in real time but rather represent inputs used during training. The crevasse indication graph 302 and the graphical representation 304 share a horizontal axis 312 which corresponds to individual measurements of the reflections 109 detected by the ground penetrating radar 102 at periodic increments. Because the ground penetrating radar 102 is traversing the surface 104 while periodically measuring the reflections 109, the horizonal axis 312 also corresponds to a distance travelled over the surface 104 by the ground penetrating radar 102.

FIG. 3C is another example of an interpretation output 300 made by the crevasse detection system 100. Like the examples depicted in FIGS. 3A and 3B, the interpretation output 300 of FIG. 3C includes a graphical representation 304 of the reflection 109. Likewise, the interpretation output 300 of FIG. 3C also has a vertical axis 309 representing the depth the radio waves 108 traveled before being reflected back to the ground penetrating radar 102 and has a horizontal axis 312 which corresponds to a distance travelled over the surface 104 by the ground penetrating radar 102.

Annotated box 314 of FIG. 3A, annotated boxes 316, 318, 320, and annotated box 322 of FIG. 3C circumscribe locations within the graphical representation 304 which likely indicate a crevasse. As can be seen in these annotated boxes, the locations which likely indicate a crevasse contain intersecting or crosshatching adjacent upside down “U” shaped curves or parabolas.

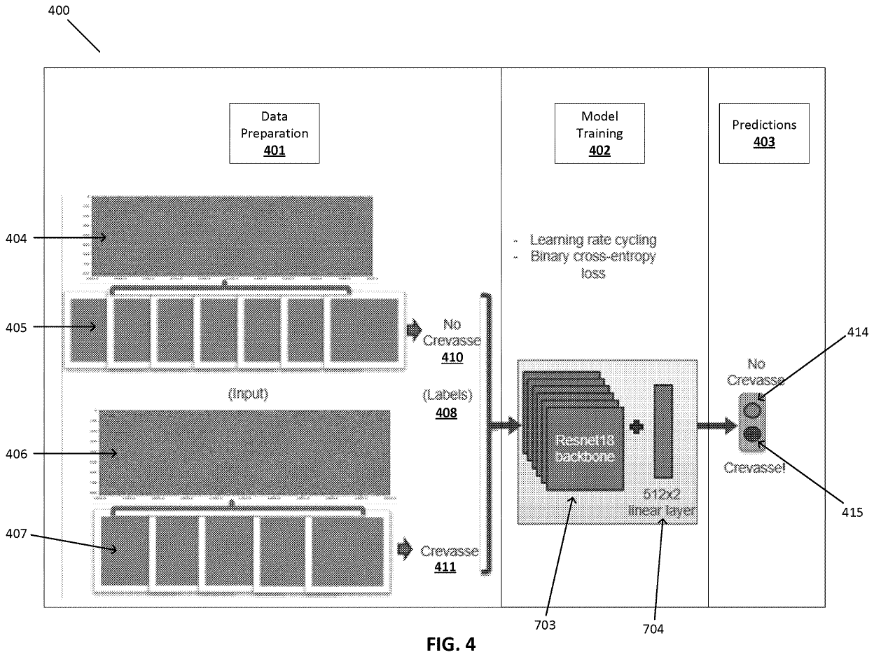

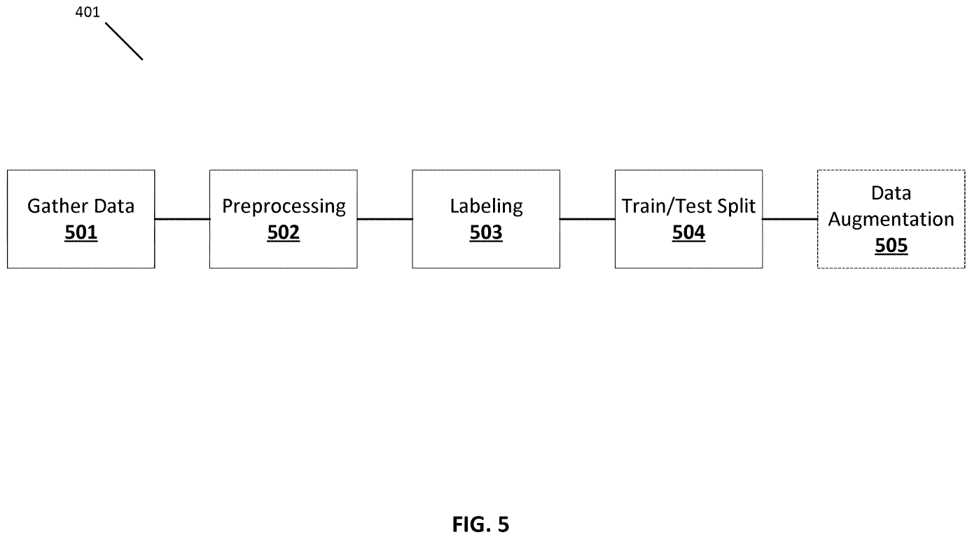

FIG. 4 depicts a method of training and using a vision model 400 to identify a crevasse 112 in data captured using ground penetrating radar 102 consistent with the present disclosure. Step 401 includes preparing the data. Preparing the data may include, for example, using the method depicted in FIG. 5.

A method of preparing data to be used in the training of a vision model to identify a crevasse in data captured using ground penetrating radar consistent with the present disclosure is depicted in FIG. 5. Step 501 includes gathering the subsurface data captured using the ground penetrating radar 404, 406, shown in FIG. 4. The subsurface data 404, 406 may include for example, publicly available or privately generated ground penetrating radar subsurface data taken in Antarctic, Arctic, and/or other locations.

Step 502 may include preprocessing the subsurface data collected in step 501. Preprocessing 502 includes generating pixelated image data from the gathered subsurface data. For example, the pixelated data may be generated having a selected bit depth (e.g., binary image data, 8-bit bit image data, etc.) and/or color image data (e.g., RGB image data, etc.). Preprocessing may also include for example, removing outlier pixels in a selected image, applying gain to the collection of pixels in a selected image, dewowing (i.e., running the pixel data through a high pass filter), filtering out high frequency information, normalizing the pixel data, filtering out horizontal edges (e.g., those indicative of a snow pack), cropping out direct surface measured energy reflections, and/or segmenting the data into discrete windows containing a selected number of scans. Removing outlier pixels may include, for example, identifying pixels having an intensity value above or below a selected number of standard deviations, establishing intensity thresholds and rejecting pixels outside of those thresholds, etc. Applying gain can include applying known automatic gain control processes to the pixels in the data set. FIG. 4 depicts the subsurface data 404, 406 collected in step 501 transformed into the preprocessed subsurface data 405, 407 produced by step 502.

Step 503 may include manually assigning labels 408 to the preprocessed data 405, 407 of step 502. Manually assigning labels 408 to the preprocessed data 405, 407 may include utilizing a subject matter expert with the skills to identify crevasses within ground penetrating data to assign the label “Crevasse” 411 to the data as indicating a crevasse or other subsurface feature and assign the label “No Crevasse” 410 to the data indicating no crevasse or subsurface feature. Such a label assignment may be generated, for example, by passing the real-time crevasse detection system over an area in which it is known, a priori, whether a crevasse exists or not within the detection range of the real-time crevasse detection system. In other embodiments, data from unknown regions may be generated and manually inspected to identify the presence or absence of a crevasse. Step 504 may include splitting the data labeled in step 503 into two sets-a training set and a test or validation set.

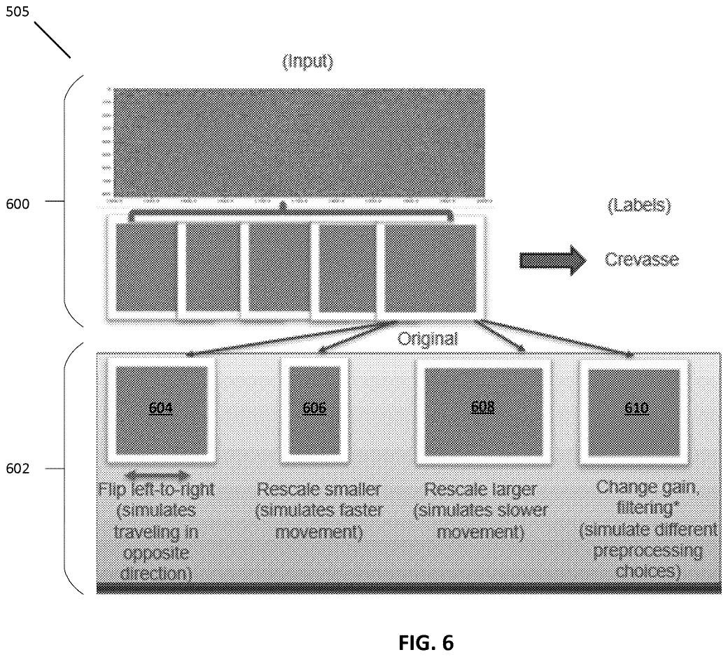

Because generating subsurface data may require excursions into locations such as Antarctica, the Arctic, or other locations which may contain subsurface features such as crevasses, the quantity of data may be limited by availability and/or feasibility of such excursion. To increase the quantity and variety of subsurface data in the training sets and testing sets, data augmentation 505 may be utilized. A method of data augmentation 505 is shown in FIG. 6. Data augmentation 505 may include randomly applying modifications to the subsurface images 600 within the training sets and testing sets to generate additional modified subsurface images 602. The modified subsurface images 602 may then be added to the training set and/or testing set to increase the quantity and variety of subsurface images within each set. The modifications to the subsurface data during data augmentation 505 may include mirroring the subsurface data 604 (i.e., to simulate travel in the opposite direction), rescaling the subsurface data so features would appear narrower 606 (i.e., to simulate subsurface images captured while traversing the surface at a faster speed), rescaling the subsurface data so features would appear wider 608 (i.e., to simulate subsurface images captured while traversing the surface at a slower speed), and/or changing the parameters used to preprocess the subsurface data 610. Other data augmentation methods may include adding noise to the subsurface data, combining multiple subsurface images into one grid-like image (i.e., mosaic augmentation) and/or cropping out sections of the subsurface data.

The data prepared in step 401 may then be used to train and evaluate a vision model in step 402. Using the vision model trained in step 402, step 403 includes integrating the model into the real-time crevasse detection system and using the model to make predictions as to the existence of a crevasse (i.e., identify crevasses) or other subsurface feature in real-time using the data generated by the ground penetrating radar as it traverses a surface of a terrain. The predictions 403 may provide a “No Crevasse” indication 414 where the model predicts no crevasse is present or a “Crevasse” indication 415 where the model predicts a crevasse or other subsurface features are present. The indications 414, 415 may be conveyed using any combination of text, color, sound, haptics, etc.

The vision model, as described herein, may be trained using artificial intelligence (AI). AI can be defined as the theory and development of computer systems able to perform tasks that normally require human intelligence, such as speech recognition, visual perception, decision-making, and translation between languages. The term AI is often used to describe systems that mimic cognitive functions of the human mind, such as learning and problem solving.

Machine learning (ML) is an application of AI that creates systems that have the ability to automatically learn and improve from experience. ML involves the development of computer programs that can access data and learn based on that data. ML algorithms typically build mathematical models based on sample, or training, data in order to make predictions or decisions without being explicitly programmed to do so. The use of training data in ML requires human intervention for feature extraction in creating the training data set. The two main types of ML are Supervised learning and Unsupervised learning. Supervised learning uses labeled datasets that are designed to train or “supervise” algorithms into classifying data or predicting outcomes accurately. Supervised learning is typically used for problems requiring classification or regression analysis. Classification problems use an algorithm to accurately assign test data into specific categories. Regression is a method that uses an algorithm to understand the relationship between dependent and independent variables. Regression models are helpful for predicting numerical values based on different data points.

A subset of supervised learning is self-supervised learning, in which labels that are easily accessible from the data without human curation are utilized to train a model. Self-supervised learning, also known as predictive or pretext learning, is a machine learning process where the model pre-trains itself on unlabeled data. For example, by masking or rearranging elements of the original data, the model trains itself predict the original data. Because the original data is available to the model, the model can judge whether the model was successful in its predictions and make changes accordingly without needing human interaction. An example of self-supervised learning is inpainting, in which an algorithm is trained to predict masked pixels in an image. The original values of the masked pixels serve as the training labels.

Unsupervised learning uses machine learning algorithms to analyze and cluster unlabeled datasets. These algorithms discover hidden patterns or data groupings without the need for human intervention, and their ability to discover similarities and differences in information make unsupervised learning the ideal solution for exploratory data analysis, cross-selling strategies, customer segmentation, and image recognition. Unsupervised learning is typically used for problems requiring clustering, e.g., K-means clustering, or association, which uses different rules to find relationships between variables in a given dataset.

Deep learning is a sub-field of ML that automates much of the feature extraction, eliminating some of the manual human intervention required and enabling the use of larger data sets. Deep learning typically uses neural networks, which consist of highly interconnected entities called nodes. Each node, or artificial neuron, connects to another and has an associated weight and activation function, which may have a thresholding component. A node multiplies the input data with the weight, which either amplifies or dampens that input, thereby assigning significance to inputs with regard to the task the algorithm is trying to learn. The activation function is applied to the weighted input data and the resulting output is then sent to the next layer of the network provided that it is above any relevant thresholds. Otherwise, no data is passed along to the next layer of the network. A neural network that consists of more than three layers can be considered a deep learning algorithm or a deep neural network.

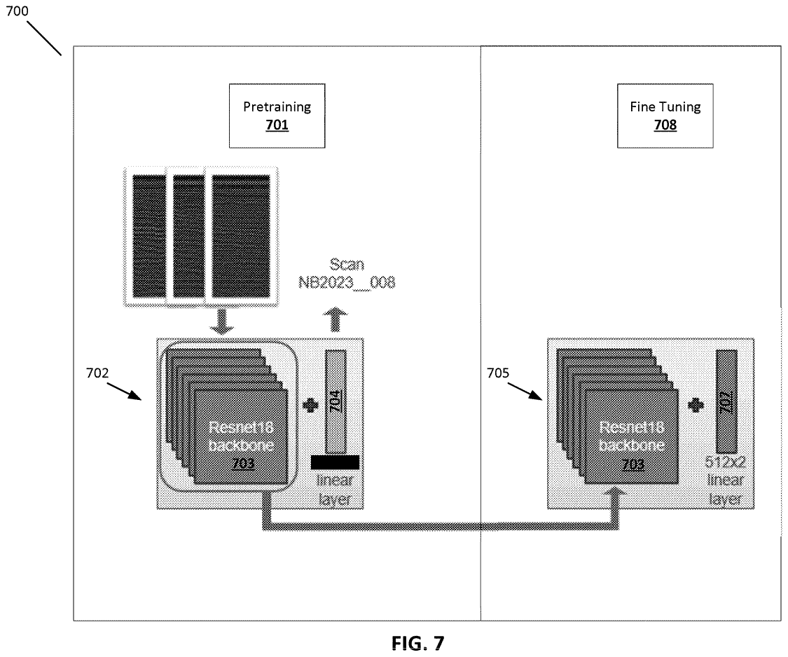

Transfer learning refers to a machine learning technique that uses knowledge created through one task to improve a model's performance of another related task. A representation of a method of transfer learning 700 is depicted in FIG. 7. Step 402 wherein the vision model is trained may include using transfer learning 700. Transfer learning 700 may include pretraining 701 a vision model 702 having a Resnet-18 backbone 703 and a 512×n files linear layer head 704. The backbone 703 consists of a set of deeper pretrained network layers used primarily for feature extraction. Resnet-18 is an open-source computer vision model and represents one of multiple backbone options. The head 704 consists of the new layers appended to the backbone which are to be trained. The vision model 702 is pretrained 701 to predict the original DZT file from which windowed images were generated (where n files is the number of original DZT files). The new vision model 705 is then constructed by replacing the head 704 of the vision model 702 with a linear layer, more specifically a 512×k classes (where k classes is the number of target classes to be predicted by the model) linear layer 707, and is fine-tuned 708 with the training set to be able to accurately identify crevasses or other features in subsurface data generated using a ground penetrating radar. For k classes=2 in the example shown, the model is configured to predict a binary result of crevasse or no crevasse.

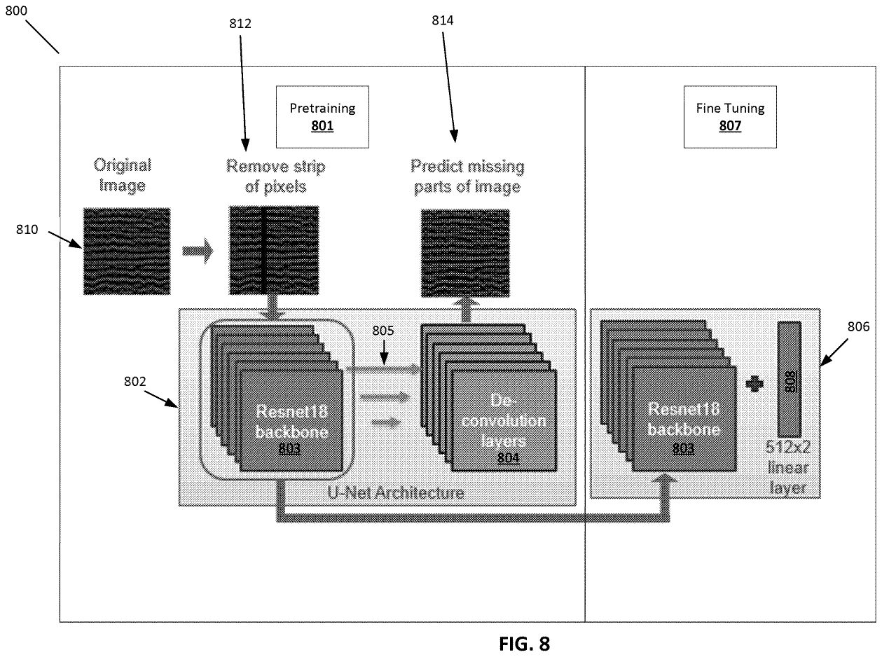

A representation of another embodiment of a method of transfer learning 800 which may be used to train the vision model in step 402 is shown in FIG. 8. The pretraining 801 may be performed by masking a portion of one or more original entries 810 within the training set to generate a set of masked entries 812. The masked entries 812 may then be “inpainted” to generate predictions of the masked portions of the entries 814. Inpainting is a known technique in the field and is described in an article titled Context Encoders: Feature Learning by Inpainting by Pathak, Krahenbuhl, Donahue, Darrell, and Efros. Generally, inpainting is a technique where an artificially intelligent model can take an image that contains an area that is missing pixels and complete the image by predicting the values of the missing pixels. The pretraining step 801 more specifically includes using a U-net architecture 802 which joins series of convolutional layers 803 and de-convolutional layers 804 by a set of skip-connections 805. Convolutional layers, as used herein, serve to encode features in as smaller-dimensional set using a series of convolution kernels. Deconvolution layers, as used herein, decode features into a larger set, again using a series of convolution kernels. Skip connections, as used herein, occur between the convolution and the parallel deconvolution layers in order to provide additional information to facilitate the deconvolution layer's decoding. The convolutional layers 803 of this U-net architecture 802, shown at the Resnet-18 backbone, are then used as the backbone of the vision model 806 to fine-tune 807 the vision model 806 in conjunction with a 512×2 linear layer 808 to predict the presence or absence of crevasses in subsurface data collected by a ground penetrating radar.

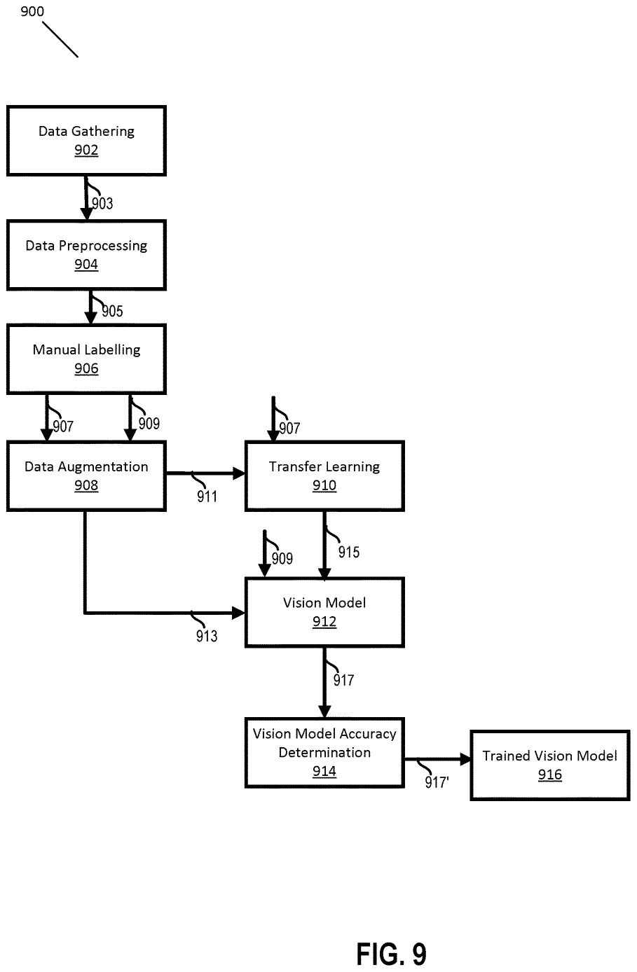

Consistent with the aspects of the present disclosure discussed in reference to FIG. 4-8, the FIG. 9 depicts a representation of a method of generating a trained vision model that may be used to identify a crevasse 112 in data captured using ground penetrating radar 102. The method 900 depicted in FIG. 9 may include gathering existing subsurface data collected from a ground penetrating radar 902. The existing subsurface data may, for example, be gathered from public or private sources of ground penetrating radar data of terrains that may contain crevasses or other subsurface features, for example the Arctic, Antarctic, or other glacial terrains. The gathered subsurface data 903 may then be preprocessed 904. Preprocessing may include generating pixelated image data from the gathered subsurface data. For example, the pixelated data may be generated having a selected bit depth (e.g., binary image data, 8-bit bit image data, etc.) and/or color image data (e.g., RGB image data, etc.). Preprocessing may also include for example, removing outlier pixels in a selected image, applying gain to the collection of pixels in a selected image, dewowing (i.e., running the pixel data through a high pass filter), filtering out high frequency information, normalizing the pixel data, filtering out horizontal edges (e.g., those indicative of a snow pack), cropping out direct surface measured energy reflections, and/or segmenting the data into discrete windows containing a selected number of scans. Removing outlier pixels may include, for example, identifying pixels having an intensity value above or below a selected number of standard deviations, establishing intensity thresholds and rejecting pixels outside of those thresholds, etc. Applying gain can include applying automatic gain control processes to the pixels in the data set.

The preprocessed pixelated subsurface data 905 may then be labelled 906. The labels assigned to the preprocessed pixelated subsurface data 905 may include, for example, crevasse where a crevasse is present, no crevasse where no crevasse is present, other feature where a subsurface feature other than a crevasse is present, ambiguous feature where it is unclear whether a crevasse or other subsurface feature is present and/or any other label representing findings implicated by the preprocessed pixelated subsurface data 905. Assigning labels 906 to the preprocessed pixelated subsurface data 905 may, for example, include utilizing a subject matter expert with the skills to identify crevasses or other subsurface features within preprocessed pixelated subsurface data 905. Such a label assignment may be generated, for example, by correlating preprocessed pixelated subsurface data collected by passing the real-time crevasse detection system over an area in which it is known, a priori, whether a crevasse exists or not within the detection range of the real-time crevasse detection system with the known state of the area (i.e., crevasse or no crevasse). In other embodiments, preprocessed pixelated subsurface data from unknown regions may be generated and manually inspected to identify the presence or absence of a crevasse.

The labelled pixelated subsurface data may then be split into a training set 907 and a test set 909 and passed through data augmentation 908. Data augmentation 908 may include randomly applying modifications to the labelled pixelated subsurface data within the training sets 907 and testing sets 909 to generate additional augmented pixelated subsurface data training sets 911 and augmented pixelated subsurface data test sets 913. The modifications to the labelled pixelated subsurface data during data augmentation 908 may include mirroring the pixelated subsurface data (i.e., to simulate travel in the opposite direction), rescaling the pixelated subsurface data so features would appear narrower (i.e., to simulate subsurface pixelated subsurface data captured while traversing the surface at a faster speed), rescaling the pixelated subsurface data so features would appear wider (i.e., to simulate subsurface pixelated data captured while traversing the surface at a slower speed), and/or changing the parameters used to preprocess the pixelated subsurface data. Other data augmentation methods may include adding noise to the pixelated subsurface data, combining multiple sets of pixelated subsurface data into one grid-like image (i.e., mosaic augmentation) and/or cropping out sections of the pixelated subsurface data.

The labelled subsurface data training set 907 and the augmented subsurface data training set 911 may then be used to train a vision model, for example using transfer learning 910. The model modified by the transfer learning 915 may then be tested as a vision model 912 by inputting the labelled subsurface data test set 909 and the augmented subsurface data test set 913 into the vision model 912. The vision model 912 may process the pixelated data within the labelled subsurface data test set 909 and the augmented subsurface data test set 913 to predict the likelihood that the pixelated data indicates a crevasse or no crevasse.

A vision model accuracy determination 914 may be performed based on a comparison between the predicted likelihoods that the pixelated data indicates a crevasse or no crevasse and the labels of the labelled subsurface data test set 909 and the augmented subsurface data test set 913 to verify whether the vision model 912 correctly predicted the likelihood that a crevasse was present in the pixelated data. If the vision model's predictions were correct at an acceptable rate (e.g., greater than 50% of the time, greater than 75% of the time, greater than 90% of the time) based on accepted safety standards, then the model may be deemed a trained vision model 916 which may be used for real-time crevasse detection. Otherwise, where the vision model's predictions were not correct at an acceptable rate, more training such as transfer learning 910 may be performed on the model 912 where the model is iteratively tested to verify the predictions produced by the model are correct at an acceptable rate. Furthermore, a vision model accuracy determination 914 may include evaluating the vision model's recall and precision.

The vision model that has been deemed acceptable after a vision model accuracy determination 917′ may then be deemed a trained vision model 916 which may be used for real-time crevasse detection.

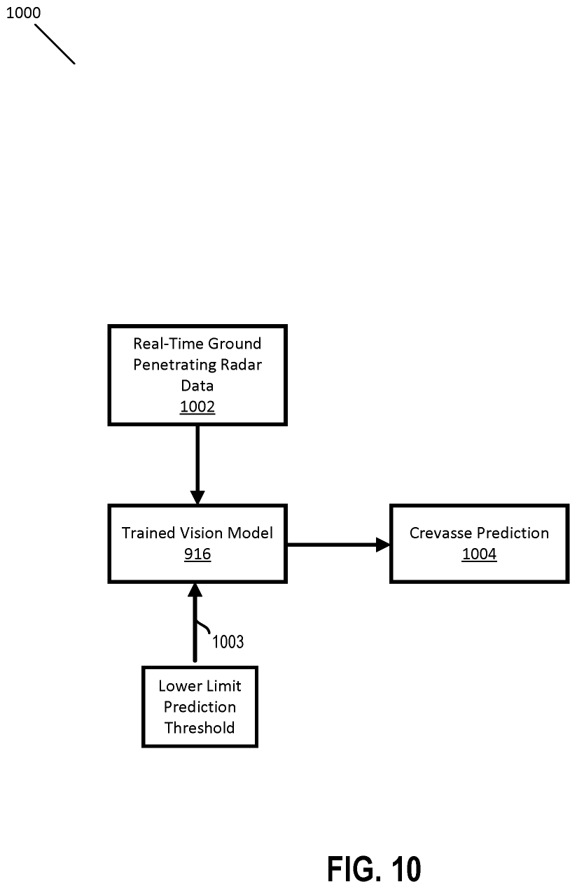

FIG. 10 depicts a method of performing crevasse detection on real-time ground penetrating radar data 1002. The real-time ground penetrating radar data 1002 may be fed to the trained vision model 916 along with user inputs such as lower limit prediction threshold 1003 (i.e., the lowest probability of there being a crevasse that would trigger the trained model to indicate a crevasse is present). The trained vision model 916 may preferably make a crevasse prediction (i.e., whether or not there is a risk of a crevasse being present that exceeds the lower limit prediction threshold) based on the trained vision model's interpretation of the real-time ground penetrating radar 1002 in light of the lower limit prediction threshold 1003. The lower limit prediction threshold may be based on acceptable risk levels and/or intended interaction with the potential crevasse (i.e., pedestrian walking, driving of heavy vehicles, surface drilling or alteration, etc.). The crevasse prediction may be indicated to a user through text, color, sound, haptics, or other sensory alerts. The crevassed prediction may be indicated to the user as a binary value (i.e., crevasse or no crevasse), as a risk level (i.e., where a risk level (e.g., high, moderate, low) correlates to a range of percentages representing the likelihood a crevasse is present), or as a percentage representing the likelihood that a crevasse is present.

Consistent with another aspect of the present disclosure, there is provided a non-transitory machine-readable storage medium that includes instructions that, when executed by a processor, cause the processor to: gather subsurface data, preprocess the subsurface data, split the subsurface data into a training set and a testing set, use the training set and testing set to train and evaluate a vision model to detect crevasses within the subsurface data, and use the vision model to detect crevasses within the subsurface data collected in real-time by a ground penetrating radar of a crevasse detection system. Additionally, the processor may be caused to perform data augmentation on the training set and/or testing set prior to training the vision model. The instructions may cause the processor to perform any aspect of a method consistent with the present disclosure.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto.

Any of the operations described herein may be implemented in a system that includes one or more non-transitory storage devices having stored therein, individually or in combination, instructions that when executed by circuitry perform the operations. Such instructions may embodied as, for example, machine code, and/or “higher level” implementations such as software programing, application (app) programming, etc. “Circuitry”, as used in any embodiment herein, may comprise, for example, singly or in any combination, hardwired circuitry, programmable circuitry such as processors comprising one or more individual instruction processing cores, state machine circuitry, and/or firmware that stores instructions executed by programmable circuitry. The circuitry may, collectively or individually, be embodied as circuitry that forms part of a larger system, for example, an integrated circuit (IC), system on-chip (SoC), application-specific integrated circuit (ASIC), programmable logic devices (PLD), digital signal processors (DSP), field programmable gate array (FPGA), logic gates, registers, semiconductor device, chips, microchips, chip sets, etc.

The storage device includes any type of tangible, non-transitory storage device, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), embedded multimedia cards (eMMCs), secure digital input/output (SDIO) cards, magnetic or optical cards, or any type of media suitable for storing electronic instructions. Other embodiments may be implemented as software executed by a programmable control device. Also, it is intended that operations described herein may be distributed across a plurality of physical devices, such as processing structures at more than one different physical location.

Accordingly, in one embodiment the present disclosure provides a real-time crevasse detection system that includes a ground penetrating radar device configured to traverse over a surface of a terrain and further configured to generate ground penetrating radar and to receive subsurface data representing reflections of the ground penetrating radar from the subsurface back to ground penetrating radar device. The system also includes a processor configured to train a vision model to identify one or more crevasses in the subsurface data; wherein to train the vision model the processor is configured to: augment a labelled training data set comprising a first plurality of images of the subsurface data to generate an augmented labelled training data set using at least one of the following processes: add noise to one or more of the first plurality of images of the subsurface data; combine multiple images of the first plurality of subsurface data into a grid-like image; crop one or more selected sections of an image of the first plurality of images of the subsurface data; and rescale a selected image of the subsurface data of the first plurality of images of the subsurface data. The processor is further configured to apply the labelled training data set, augmented labelled training data set, and a labelled test data set to the vision model to generate a trained vision model; wherein the trained vision model is configured to generate a prediction value of the presence of a crevasse within an image of the labelled test data set. The processor is further configured to receive real-time subsurface image data; and apply the real-time subsurface image data to the trained vision model to determine a predicted value of the presence of a crevasse within the real-time subsurface image data.

In another embodiment, the present disclosure provides a non-transitory storage device that includes machine-readable instructions that, when executed by one or more processors, cause the one or more processors to perform operations, comprising: train a vision model to identify one or more crevasses in subsurface image data; wherein to train the vision model the one or more processors are configured to: augment a labelled training data set comprising a first plurality of images of the subsurface data to generate an augmented labelled training data set using at least one of the following processes: add noise to one or more of the first plurality of images of the subsurface data; combine multiple images of the first plurality of subsurface data into a grid-like image; crop one or more selected sections of an image of the first plurality of images of the subsurface data; and rescale a selected image of the subsurface data of the first plurality of images of the subsurface data. Operations further include apply the labelled training data set, augmented labelled training data set, and a labelled test data set to the vision model to generate a trained vision model; wherein the trained vision model is configured to generate a prediction value of the presence of a crevasse within an image of the labelled test data set. Operations further include receive real-time subsurface image data; and apply the real-time subsurface image data to the trained vision model to determine a predicted value of the presence of a crevasse within the real-time subsurface image data.

In another embodiment, the present disclosure provides a method for real-time crevasse detection. The method includes training a vision model to identify one or more crevasses in subsurface image data; wherein to train the method includes augmenting a labelled training data set comprising a first plurality of images of the subsurface data to generate an augmented labelled training data set using at least one of the following processes: adding noise to one or more of the first plurality of images of the subsurface data; combining multiple images of the first plurality of subsurface data into a grid-like image; cropping one or more selected sections of an image of the first plurality of images of the subsurface data; and rescaling a selected image of the subsurface data of the first plurality of images of the subsurface data. The method further includes applying the labelled training data set, augmented labelled training data set, and a labelled test data set to the vision model to generate a trained vision model; wherein the trained vision model is configured to generate a prediction value of the presence of a crevasse within an image of the labelled test data set. The method further includes receiving real-time subsurface image data; and applying the real-time subsurface image data to the trained vision model to determine a predicted value of the presence of a crevasse within the real-time subsurface image data.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems. The terms “connected” or “coupled” as used herein is a relative term and does not require a direct physical connection, unless otherwise stated.

Throughout the entirety of the present disclosure, use of the articles “a” and/or “an” and/or “the” to modify a noun may be understood to be used for convenience and to include one, or more than one, of the modified noun, unless otherwise specifically stated. The terms “comprising,” “including,” and “having” are intended to be inclusive and mean that there may be additional elements other than the listed elements.

Although the methods and systems have been described relative to a specific embodiment thereof, they are not so limited. Obviously, many modifications and variations may become apparent in light of the above teachings. Many additional changes in the details, materials, and arrangement of parts, herein described and illustrated, may be made by those skilled in the art.

What is claimed is:

1. A real-time crevasse detection system comprising:
a ground penetrating radar device configured to traverse over a surface of a terrain and further configured to generate ground penetrating radar and to receive subsurface data representing reflections of the ground penetrating radar from the subsurface back to ground penetrating radar device; and
a processor configured to train a vision model to identify one or more crevasses in the subsurface data; wherein to train the vision model the processor is configured to:
augment a labelled training data set comprising a first plurality of images of the subsurface data to generate an augmented labelled training data set using at least one of the following processes:
add noise to one or more of the first plurality of images of the subsurface data;
combine multiple images of the first plurality of subsurface data into a grid-like image;
crop one or more selected sections of an image of the first plurality of images of the subsurface data; and
rescale a selected image of the subsurface data of the first plurality of images of the subsurface data;
apply the labelled training data set, augmented labelled training data set, and a labelled test data set to the vision model to generate a trained vision model; wherein the trained vision model is configured to generate a prediction value of the presence of a crevasse within an image of the labelled test data set;
the processor is further configured to:
receive real-time subsurface image data;
apply the real-time subsurface image data to the trained vision model to determine a predicted value of the presence of a crevasse within the real-time subsurface image data.

2. The system of claim 1, where the processor is further configured to:
augment the labelled test data set that comprises a second plurality of images of the subsurface data to generate an augmented labelled test data set using at least one of the following processes:
add noise to one or more of the second plurality of images of the subsurface data;
combine multiple images of the second plurality of subsurface data into a grid-like image;
crop one or more selected sections of an image of the second plurality of images of the subsurface data; and
rescale a selected image of the subsurface data of the second plurality of images of the subsurface data; and
apply the augmented labelled test data set to the vision model to generate the trained vision model.

3. The crevasse detection system of claim 1, wherein the labeled training data includes a first subset of images of the first plurality of images that are labelled as indicating a crevasse is present in the first subset of images; and wherein the labelled training data further includes a second subset of images of the first plurality of images that are labelled as indicating that no crevasse is present in the second subset of images.

4. The crevasse detection system of claim 1, wherein the processor is further configured to pretrain the vision model by applying a transfer learning process using the labelled training data set.

5. The crevasse detection system of claim 1, wherein the processor is further configured to pretrain the vision model by applying an inpainting learning process using the labelled training data set.

6. The crevasse detection system of claim 1, wherein determine a predicted value of the presence of a crevasse within the real-time subsurface image data includes determining, by the trained vision model, one or more geometric shapes within the real-time subsurface image indicative of a crevasse.

7. The crevasse detection system of claim 1, wherein the trained vision model is further configured to apply a lower limit prediction threshold to determine the predicted value of the presence of a crevasse within the real-time subsurface image data; wherein the lower limit prediction threshold represents a selectable value below which the predicted value is indicative of no crevasse present in the real-time subsurface image data.

8. A non-transitory storage device that includes machine-readable instructions that, when executed by one or more processors, cause the one or more processors to perform operations, comprising:
train a vision model to identify one or more crevasses in subsurface image data; wherein to train the vision model the operations include:
augment a labelled training data set comprising a first plurality of images of the subsurface data to generate an augmented labelled training data set using at least one of the following processes:
add noise to one or more of the first plurality of images of the subsurface data;
combine multiple images of the first plurality of subsurface data into a grid-like image;
crop one or more selected sections of an image of the first plurality of images of the subsurface data; and
rescale a selected image of the subsurface data of the first plurality of images of the subsurface data;
apply the labelled training data set, augmented labelled training data set, and a labelled test data set to the vision model to generate a trained vision model; wherein the trained vision model is configured to generate a prediction value of the presence of a crevasse within an image of the labelled test data set; and
receive real-time subsurface image data; and
apply the real-time subsurface image data to the trained vision model to determine a predicted value of the presence of a crevasse within the real-time subsurface image data.

9. The non-transitory storage device of claim 8, further comprising machine-readable instructions that, when executed by one or more processors, cause the one or more processors to perform further operations, comprising:
augment the labelled test data set that comprises a second plurality of images of the subsurface data to generate an augmented labelled test data set using at least one of the following processes:
add noise to one or more of the second plurality of images of the subsurface data;
combine multiple images of the second plurality of subsurface data into a grid-like image;
crop one or more selected sections of an image of the second plurality of images of the subsurface data; and
rescale a selected image of the subsurface data of the second plurality of images of the subsurface data; and
apply the augmented labelled test data set to the vision model to generate the trained vision model.

10. The non-transitory storage device of claim 8, wherein the labeled training data includes a first subset of images of the first plurality of images that are labelled as indicating a crevasse is present in the first subset of images; and wherein the labelled training data further includes a second subset of images of the first plurality of images that are labelled as indicating that no crevasse is present in the second subset of images.

11. The non-transitory storage device of claim 8, further comprising machine-readable instructions that, when executed by one or more processors, cause the one or more processors to perform further operations, comprising: pretrain the vision model by applying a transfer learning process using the labelled training data set.

12. The non-transitory storage device of claim 8, further comprising machine-readable instructions that, when executed by one or more processors, cause the one or more processors to perform further operations, comprising: pretrain the vision model by applying an inpainting learning process using the labelled training data set.

13. The non-transitory storage device of claim 8, wherein to determine a predicted value of the presence of a crevasse within the real-time subsurface image data includes determining, by the trained vision model, one or more geometric shapes within the real-time subsurface image indicative of a crevasse.

14. The non-transitory storage device of claim 8, wherein the trained vision model is further configured to apply a lower limit prediction threshold to determine the predicted value of the presence of a crevasse within the real-time subsurface image data; wherein the lower limit prediction threshold represents a selectable value below which the predicted value is indicative of no crevasse present in the real-time subsurface image data.

15. A method for real-time crevasse detection, comprising:
training a vision model to identify one or more crevasses in subsurface image data; wherein to train the vision model includes:
augmenting a labelled training data set comprising a first plurality of images of the subsurface data to generate an augmented labelled training data set using at least one of the following processes:
adding noise to one or more of the first plurality of images of the subsurface data;
combining multiple images of the first plurality of subsurface data into a grid-like image;
cropping one or more selected sections of an image of the first plurality of images of the subsurface data; and
rescaling a selected image of the subsurface data of the first plurality of images of the subsurface data;
applying the labelled training data set, augmented labelled training data set, and a labelled test data set to the vision model to generate a trained vision model; wherein the trained vision model is configured to generate a prediction value of the presence of a crevasse within an image of the labelled test data set; and
receiving real-time subsurface image data; and
applying the real-time subsurface image data to the trained vision model to determine a predicted value of the presence of a crevasse within the real-time subsurface image data.

16. The method of claim 15, further comprising:
augmenting the labelled test data set that comprises a second plurality of images of the subsurface data to generate an augmented labelled test data set using at least one of the following processes:
adding noise to one or more of the second plurality of images of the subsurface data;
combining multiple images of the second plurality of subsurface data into a grid-like image;
cropping one or more selected sections of an image of the second plurality of images of the subsurface data; and
rescaling a selected image of the subsurface data of the second plurality of images of the subsurface data; and
applying the augmented labelled test data set to the vision model to generate the trained vision model.

17. The method of claim 15, wherein the labeled training data includes a first subset of images of the first plurality of images that are labelled as indicating a crevasse is present in the first subset of images; and wherein the labelled training data further includes a second subset of images of the first plurality of images that are labelled as indicating that no crevasse is present in the second subset of images.

18. The method of claim 15, further comprising pretraining the vision model by applying a transfer learning process using the labelled training data set.

19. The method of claim 15, further comprising pretraining the vision model by applying an inpainting learning process using the labelled training data set.

20. The method of claim 15, wherein to determine a predicted value of the presence of a crevasse within the real-time subsurface image data includes determining, by the trained vision model, one or more geometric shapes within the real-time subsurface image indicative of a crevasse.

21. The method of claim 15, wherein the trained vision model is further configured to apply a lower limit prediction threshold to determine the predicted value of the presence of a crevasse within the real-time subsurface image data; wherein the lower limit prediction threshold represents a selectable value below which the predicted value is indicative of no crevasse present in the real-time subsurface image data.
